(19) United States
(12) Patent Application Publication
(10) Pub. No.: US 2024/0338671 A1
(43) Pub. Date: Oct. 10, 2024

(54) ITEM REGISTRATION APPARATUS AND METHOD, AND CART POINT-OF-SALE SYSTEM

(71) Applicant: Toshiba Tec Kabushiki Kaisha, Tokyo (JP)

(72) Inventor: Suguru KATO, Sunto Shizuoka (JP)

(21) Appl. No.: 18/582,473

(22) Filed: Feb. 20, 2024

(30) Foreign Application Priority Data
Apr. 7, 2023 (JP) 2023-063024

(51) Int. Cl. G06Q 20/20; G06Q 30/0601; G06V 10/141

(52) U.S. Cl. CPC G06Q 20/208; G06Q 30/0633; G06Q 30/0641; G06V 10/141; G06V 2201/07

(57) ABSTRACT

An item registration apparatus for registering an item for purchase in a store, includes a camera, a lamp disposed adjacent to the camera, and a processor configured to: control the camera to capture a first image using first settings, perform an object recognition process on the image, and determine whether a package of an item is in the image, upon determining that a package of an item is in the image, register the item for purchase, upon determining that a package of an item is not in the image, control the lamp to turn on and control the camera to capture a second image using second settings, perform a code recognition process on the second image, and determine whether a code of an item is in the second image, and upon determining that a code of an item is in the second image, register the item using the code.

### CROSS-REFERENCE TO RELATED APPLICATION(S)

This application is based upon and claims the benefit of priority from Japanese Patent Application No. 2023-063024, filed Apr. 7, 2023, the entire contents of which are incorporated herein by reference.

### FIELD

Embodiments described herein relate generally to an item registration apparatus and method, and a cart point-of-sale (POS) system.

### BACKGROUND

Conventionally, when an item is purchased at a store, the item is registered using a register installed in the store, and a checkout process is performed after the registration. Recently, a cart POS system has been proposed in which an information terminal having a touch panel and a barcode scanner is attached to a shopping cart for item registration. When a customer places an item in such a shopping cart, the customer holds the item near the barcode scanner so that the barcode scanner can read a barcode or a two-dimensional barcode (e.g., QR code©) attached to the item using a barcode recognition technique.

Furthermore, there is a cart POS system using AI (artificial intelligence) technologies, in which a shopping cart is referred to as an AI cart, a smart cart, or an intelligent cart. In this POS system, an AI-based object recognition technique is used on an image captured by an imaging device disposed around a basket of the cart. When an item is taken in and out of the basket, the item is imaged and automatically identified for registration and cancellation. That is, this object recognition technique enables automatic registration or cancellation of an item without requiring a customer take any specific actions for reading a barcode attached to or printed on the item.

However, since the current object recognition technology cannot identify all of the items perfectly, it is necessary to use the barcode recognition technology in combination, and the above-described terminal having a barcode scanner is often attached to a shopping cart. In such a configuration, it is necessary to switch between the imaging device and the barcode scanner for identifying an item, which is confusing to a customer. Further, since the information terminal equipped with a barcode scanner is installed outside the basket, it is difficult for a customer to know a reading position at which the barcode of an item can be read.

### SUMMARY OF THE INVENTION

Embodiments of the present disclosure provide an article registration apparatus and a cart POS system equipped with the article registration apparatus for performing the identification code recognition by using an imaging device and a lighting unit used for object recognition to indicate the shooting area to which the identification code should be held by illumination, instead of separately using a barcode scanner when the item is not recognized by object recognition by AI.

In one embodiment, an item registration apparatus for registering an item for purchase in a store, includes a camera; a lamp disposed adjacent to the camera; and a processor configured to: control the camera to capture a first image using first settings, perform an object recognition process on the first image, and determine whether a package of an item is in the first image, upon determining that a package of an item is in the first image, register the item for purchase, upon determining that a package of an item is not in the first image, control the lamp to turn on and control the camera to capture a second image using second settings, perform a code recognition process on the second image, and determine whether a code of an item is in the second image, and upon determining that a code of an item is in the second image, register the item for purchase using the code.

### BRIEF DESCRIPTION OF THE DRAWINGS

FIG. 1 is a block diagram of an overall configuration of a cart POS system including an item registration apparatus according to an embodiment.

FIG. 2 is a schematic diagram illustrating a main data structure of an information terminal table.

FIG. 3 is a block diagram illustrating a hardware configuration of an item registration apparatus of the cart POS system including an information terminal.

FIG. 4 is a diagram illustrating an overall configuration of a shopping cart to which the item registration apparatus is attached.

FIG. 5 is a flowchart for explaining a procedure for registering an item using the information terminal.

FIG. 6 is a flowchart for explaining a procedure of recovery when an item cannot be recognized by the information terminal.

### DETAILED DESCRIPTION

Embodiments of this disclosure will be described below with reference to the drawings. Such embodiments provide a card POS system 1 including an item registration apparatus 100 with an information terminal 7, which will be described later, a camera 8, which is an imaging device, and a lighting unit 9, which is an illumination device. In the following explanation, a barcode or a two-dimensional barcode (e.g., QR code©) attached to or printed on an item is used to identify the item.

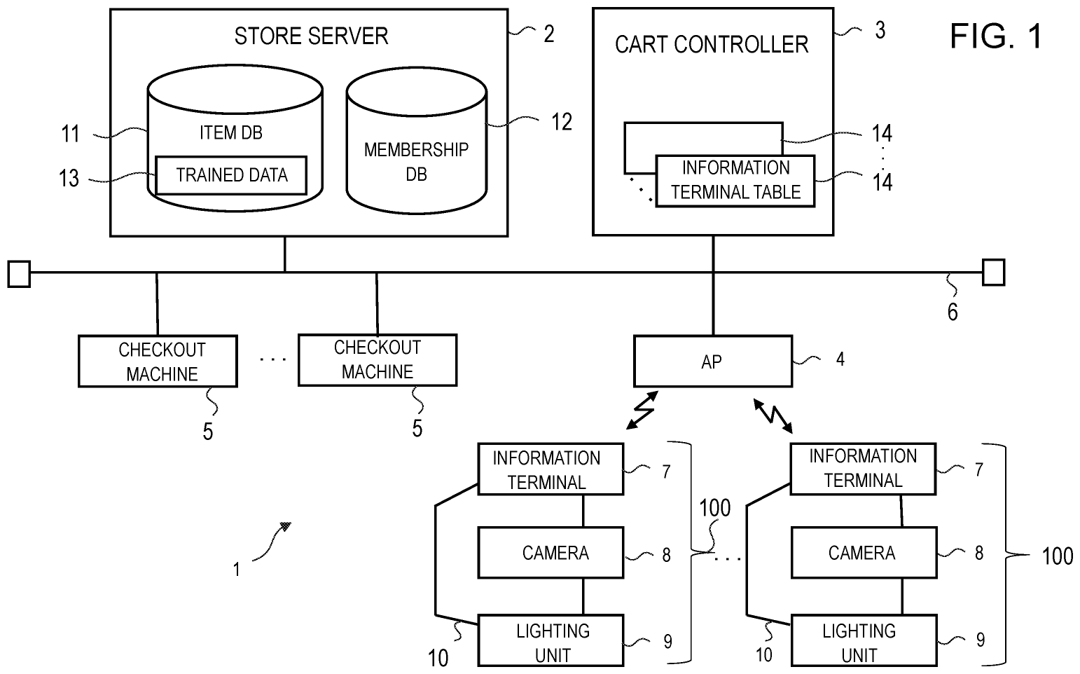

FIG. 1 is an overall configuration diagram of a cart POS system 1 according to a first embodiment. The cart POS 1 includes a store server 2, a cart controller 3, an access point (AP) 4, and a checkout machine 5. The store server 2, the cart controller 3, the access point 4, and the checkout machine 5 are connected to a network 6 such as a local area network (LAN) or a wireless LAN. The cart POS system 1 includes a plurality of information terminals 7 connected to the network 6 via the access point 4.

The item registration apparatus 100 is a device that enables a customer who is a purchaser to self-register an item to be purchased by using the information terminal 7 and the camera 8. The information terminal 7 and the camera 8 are attached to a shopping cart 10. Hereinafter, the shopping cart 10 is simply referred to as the cart 10. A plurality of carts 10 are provided, and each cart 10 includes an information terminal 7, a camera 8, and a lighting unit 9. The cart 10 is a carrier that conveys an item to be purchased by a customer. Further, a chargeable battery 18 for driving the information terminal 7, the camera 8, and the lighting unit 9 is mounted on the cart 10.

The information terminal 7 is an information processing device that functions as a user interface for an operation related to registration of an item or cancellation of registration (hereinafter, simply referred to as “cancellation”). The information terminal 7 includes a wireless unit as a communication unit with the access point 4. The access point 4 relays communication between each device connected to the network 6, that is, the store server 2, the cart controller 3, and the checkout machine 5, and the information terminal 7. Although only one access point 4 is shown in FIG. 1, two or more access points 4 may be provided depending on the size of the store or the like.

The checkout machine 5 is a device that enables a store clerk or a customer to perform checkout for registered items. As the checkout machine 5, for example, a conventional POS terminal is used when a store clerk performs checkout, and a self-service POS terminal is used when a customer performs checkout. The number of checkout machines 5 is not particularly limited.

The store server 2 provides, for example, a checkout service, a purchasing service, an inventory management service, a customer service (providing customer service, dealing with complaints, and the like) and the like as store services. For providing those services, the store servers 2 manage item database (DB) 11, and membership database (DB) 12, etc.

The item database 11 stores item records storing item data for each item sold in the store. The item record includes an item code, a price, an item name and the like. The item code is an identification code of the item.

In the present embodiment, the item database 11 stores trained data 13 trained in advance for recognizing the items registered in the item database 11 using AI technologies. The trained data 13 is a set of pieces of data related to information (e.g., content, shape, package, wrapping pattern, trade name or characters printed, and the like) of each item sold at the store, and the pieces of data are incorporated in the trained data 13 in association with, for example, the corresponding item codes. In the trained data 13, trained data 13 relating to one item can be updated in accordance with an update of the item database 11 in accordance with addition or replacement of the item sold in the store. The trained data 13 of each item may be provided by the provider of the item and provided to the store, or may be independently provided by the store.

The membership database 12 stores member records storing member data for each member. The member data includes a membership ID, a name, a gender, an e-mail address, and the like. The member ID is a unique member number or the like set for each member in order to identify each member. The member owns a recording medium in which the member ID is recorded. The recording medium is, for example, a magnetic card, a contact-type IC (Integrated Circuit) card, a contactless IC card, a smart phone, or the like.

Although not particularly shown, the store server 2 may further manage a member payment database. The member payment database stores, for each member, a member payment record storing data necessary for payment of a price. The member payment record includes an electronic money identification code and an electronic money user ID in addition to the member ID.

The cart POS system 1 according to the present embodiment restricts a payment method in which a member does not use the checkout machine 5, that is, when no cash payment is made, to one type of electronic money. The electronic money identification code is an identification code of electronic money registered in advance by the member identified by the member ID as being used for payment. The electronic money user ID is an identity for an electronic money center (EMC) to identify the user of the electronic money and is granted by the EMC.

The member registers the electronic money identification code and the electronic money ID in advance, for example, at the time of registering the member, in order to enable the electronic money to be paid. When the electronic money is not registered in advance, NULL or 0000 is stored in the electronic money identification code and the electronic money ID of the account payment record. When the electronic money is enabled in this way, the store server 2 has a function of a communication server, or the cart POS system 1 includes such a server. The store server 2 or the communication server assists in data communication processing between the checkout machine 5 or the cart controller 3 and the EMC that manages payment by electronic money via an external communication network such as the Internet or an electronic money dedicated network.

The cart controller 3 cooperates with the information terminal 7 to assist the information terminal 7 to function as a POS terminal. The cart controller 3 stores an information terminal table 14 corresponding to each of the information terminals 7. In the present embodiment, an example in which the information terminal table 14 is stored in the cart controller 3 will be described, but it may be stored in the auxiliary storage device 23 of the corresponding information terminal 7. In such a case, the information terminal table 14 may be managed by the store server 2. Note that the information terminal table 14 can be an element of the item registration apparatus 100.

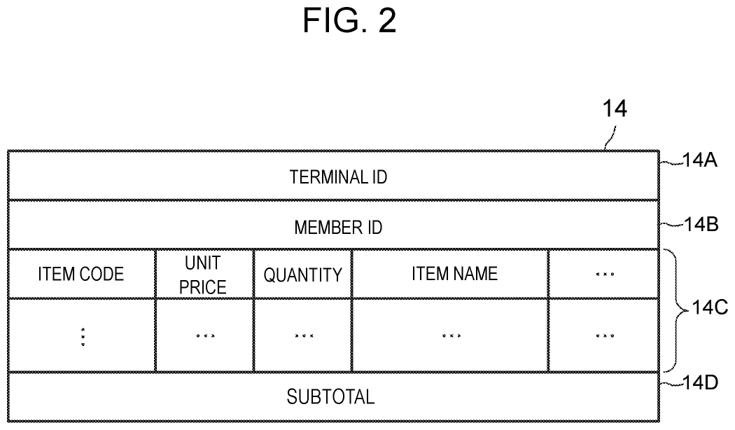

FIG. 2 is a schematic diagram illustrating a data structure of the information terminal table 14. As illustrated in FIG. 2, the information terminal table 14 includes a terminal ID field 14a, a member ID field 14b, one or more purchased item data fields 14c, and a subtotal field 14d. The terminal ID field 14a stores a terminal ID which is a terminal number or the like for uniquely identifying the information terminal 7 corresponding to the information terminal table 14. The member ID field 14b stores the member ID. The purchased item data fields 14c corresponding to a list of the items to be purchased that is updated each time a customer registers an item to be purchased using the information terminal 7. Further, the list is updated every time the customer stops purchasing the item registered in the information terminal 7 and cancels the registration. Each field 14c indicates an item code, a unit price, a sales score (number), an item name, a sales amount, a tax amount, and the like of the item to be purchased by the customer. The subtotal field 14d indicates the total amount of payment including the tax amount for all the items to be purchased by the customer, which is calculated by totaling the prices of the items indicated by the purchased item data fields 14c. This amount is updated every time a customer registers or cancels an item to be purchased, similarly to the items to be purchased list.

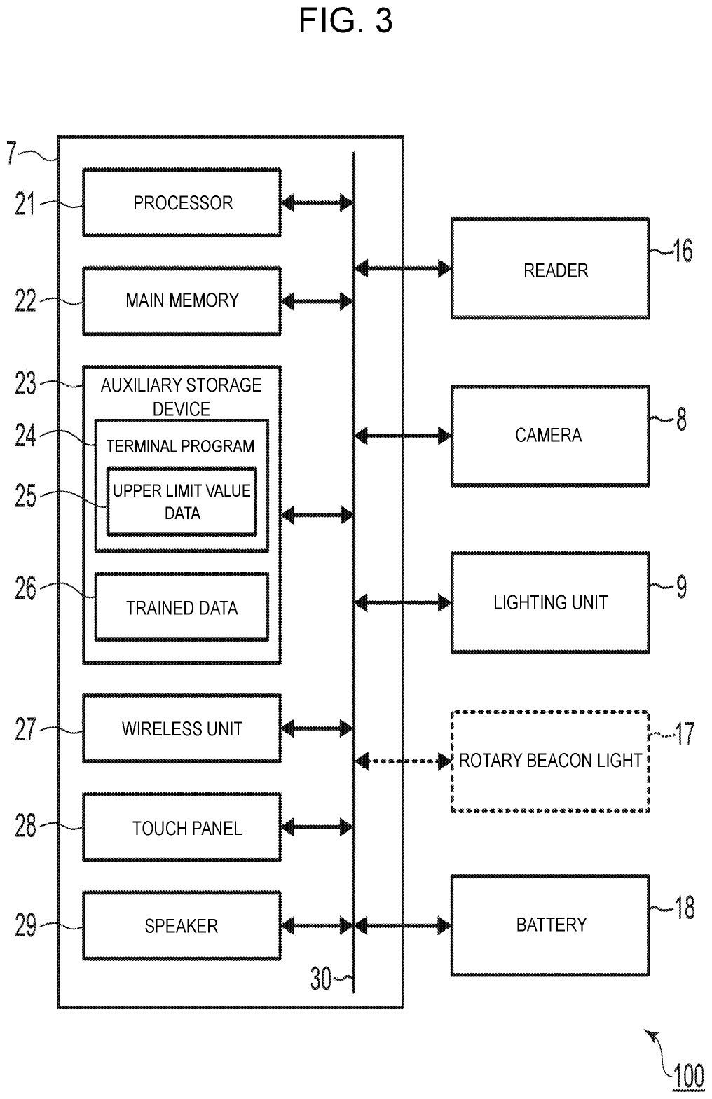

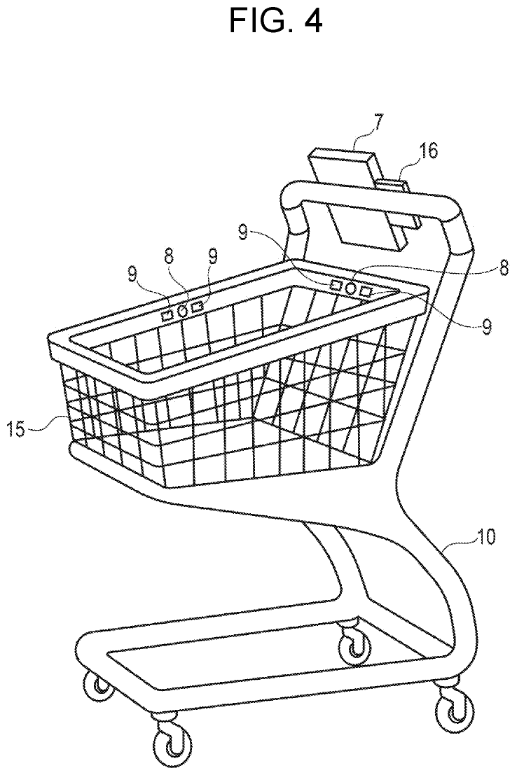

FIG. 3 is a block diagram illustrating a hardware configuration of the item registration apparatus 100 including the information terminal 7. FIG. 4 is a schematic diagram showing the attachment positions of the information terminal 7, the camera 8, and the lighting unit 9 to the cart 10. In addition, a reader 16 is disposed adjacent to the information terminal 7. The information terminal 7 may be a dedicated device or a tablet-type computer.

The information terminal 7 includes a processor 21, a main memory 22, an auxiliary storage device 23, a wireless unit 27, a touch panel 28, a speaker 29, and a system transmission path 30. The system transmission path 30 includes an address bus, a data bus, a control signal line, and the like. In the information terminal 7, the processor 21, the main memory 22, the auxiliary storage device 23, the wireless unit 27, the touch panel 28, and the speaker 29 are connected to each other via the system transmission path 30. The reader 16 and the camera 8 are connected to the system transmission path 30 via an interface circuit (not shown). It is assumed that the system transmission path 30 also includes a power supply line for supplying power from the battery 18 to each component.

The processor 21 corresponds to a core component of the information terminal 7. The processor 21 controls each unit of the information terminal 7 in accordance with an operating system or an application program so as to perform various functions including a function of performing a registration process and a cancellation process of an item, an object recognition process, and an identification code recognition process. The processor 21 controls the shooting timing or shutter timing of the camera, in this case, the timing at which the pixel signal is read from the image sensor, using a trigger signal. When the item cannot be recognized by the object recognition, the processor 21 switches from an application program that executes the object recognition process to an application program that executes the identification code recognition process, and further switches the camera shooting mode from a continuous image mode in which the object recognition is performed to an identification code close-up mode (described later) in which the identification code recognition is performed. Conversely, when the application program is switched back from the identification code recognition process to the object recognition process, the camera is switched back from the identification code close-up mode to the continuous image mode.

The processor 21 is, for example, a central processing unit (CPU), but is not limited thereto. In addition, the processor 21 may be a multi-core/multi-thread processing circuit, and may execute a plurality of processes in parallel. Further, the processor 21 can include an AI chip specialized for AI processing. Further, the processor 21 may be implemented in various other forms, including an integrated circuit such as a graphics processing unit (GPU), an application specific integrated circuit (ASIC), a field-programmable gate array (FPGA), a digital signal processor (DSP), and the like.

The main memory 22 includes a non-volatile memory area and a volatile memory area. The non-volatile memory area of the main memory 22 stores at least an operating system or an application program. The non-volatile or volatile memory area of the main memory 22 may store data necessary for the processor 21 to execute a process for controlling each unit. The volatile memory area of the main memory 22 is used as a work area in which data is rewritten by the processor 21. The non-volatile memory area is, for example, a read only memory (ROM). The volatile memory area is, for example, a random access memory (RAM).

The auxiliary storage device 23 is, for example, an electric erasable programmable read-only memory (EEPROM), a hard disc drive (HDD), or a solid state drive (SSD). The auxiliary storage device 23 stores data used by the processor 21 to perform various types of processing, data created by processing by the processor 21, and the like. The auxiliary storage device 23 may store an application program for the processor 21 to execute the above functions and processes. In the present embodiment, as the application program, the terminal program 24 for executing the functions of the information terminal 7, the camera 8, and the lighting unit 9 (i.e., the item registration and cancellation process, the object recognition process, and the identification code recognition process) is stored.

In addition, terminal program 24 includes upper limit value data 25 defining the upper limit value of the number of items that can be placed in the cart 10 at the same time. The terminal program 24 may be stored in the main memory 22. Further, the auxiliary storage device 23 stores the trained data 26 trained for recognizing the items sold in the store and registered in the item database 11 of the store server 2 using AI. The trained data 26 may be a copy of the trained data 13 stored in the item database 11 of the store server 2. The timing at which the trained data 13 is copied as the trained data 26 may be a specific timing such as when the information terminal 7 is activated every time, or may be any timing such that the trained data is distributed from the store server 2 to each information terminal 7 at the time of updating the trained data 26.

The wireless unit 27 is a network interface circuit that performs wireless communication of data with the access point 4 in accordance with a wireless communication protocol.

The touch panel 28 is a device that combines an input device and a display device of the information terminal 7. The touch panel 28 displays an image based on the image data generated by the processor 21 and detects a touch position with respect to the displayed image, which can be acquired by the processor 21. As shown in FIG. 4, the information terminal 7 is attached to the cart 10 in a direction and at a position such that the customer can view the display of the touch panel 28 and can easily perform the touch operation.

The speaker 29 is housed in the housing of the information terminal 7 and outputs sound based on the sound data generated by the processor 21. The sound to be output includes a voice guide, a confirmation sound, an alert alarm sound, and the like. For example, when the object recognition of an item fails, the voice guide instructs the user to read the identification code of the item and perform the identification code recognition process by voice. Further, information related to the calling of the store clerk (such as a notification calling the store clerk and a voice of the responding store clerk) may be output by voice.

The reader 16 reads the data recorded on the recording medium, which is then acquired by the processor 21. The reader 16 is a magnetic card reader when the recording medium is a magnetic card, and is an IC card reader when the recording medium is a contact-type IC card. The reader 16 is a radio frequency identification (RFID) reader when the recording medium is a contactless IC card or smart phone. The reader 16 can be attached to any part of the cart 10. For example, as shown in FIG. 4, the reader 16 may be mounted adjacent to the information terminal 7.

As shown in FIG. 4, four cameras 8 are provided in the cart 10 so that the inside of the basket 15 of the cart 10 can be imaged from the front, rear, left, and right sides at the upper portion of the basket 15. In this example, one camera 8 and two lighting units 9 are used as one imaging unit, and one imaging unit is arranged on each side so as to surround the square edge of the upper portion of the basket 15. Here, although an example in which the lighting unit 9 is arranged on both sides of the camera 8 is shown, one lighting unit 9 may be arranged on either side of the camera 8. In addition, in the present embodiment, an example is shown in which the lighting unit 9 is disposed so as to be laterally adjacent to the camera 8, but if the inside of the shooting area can be illuminated from the camera 8 side, the position at which the lighting unit 9 is disposed is not limited, and may be disposed above the camera 8 in the opening of the basket 15, for example. In addition, the thickness of the edge portion is increased so that an item being taken in and out of the backet 15 and the camera 8 and the lighting unit 9 do not collide with each other. In this embodiment, a configuration example in which four cameras are arranged in four directions has been described, but, of course, it is possible to implement the present embodiment using at least one camera or five or more cameras.

The camera 8 is used to monitor an item in the basket 15 by taking continuous images of an item to be placed into or taken out from the basket 15 of the cart 10.

On both sides of the camera 8, light emitting diode (LED) lamps are provided as lighting units 9. Each lighting unit 9 is used in an environment in which the exposure amount is too small (i.e., the store is too dark) to continuously capture images in the basket 15 or in an identification code recognition process using the camera 8. The identification code recognition greatly affects the blur of the captured screen as compared with the object recognition. Therefore, it is necessary to shorten the exposure time as much as possible so that blur does not occur in the captured bar, but illumination for increasing the exposure amount of the subject is necessary in order to brighten the image because the exposure time is shortened. In addition, since there is an influence of contrast of light and dark, the reading depth is also shortened or the depth of field is shallowed. Therefore, in the case of a continuous image mode (or a normal mode) in which a moving image or a continuous image for which object recognition is performed is captured, a shooting mode in which the exposure time is shortened and the focal length is shortened (corresponding to the reading depth (DOF: Depth Of Field) in the barcode reader) in order to perform identification code recognition is referred to as an identification code close-up mode.

The illumination light of the lighting unit 9 in the present embodiment is set to be turned on at a timing at which the camera 8 captures an identification code using, for example, an LED lamp. The processor 21 controls the operation of the camera 8 and the lighting unit 9. In general, the object recognition in the continuous image mode is superior to the identification code recognition in terms of the exposure amount when the entire inside of the basket 15 is imaged by the camera 8, that is, it can be easily imaged. Therefore, the item is normally recognized only by object recognition without illumination light, and only when the item cannot be recognized, the item is irradiated with illumination light and the identification code is imaged to register the item. As described above, the processor 21 controls the light emission of the lighting unit 9, so that the power consumption of the battery 18 mounted on the cart 10 can be suppressed.

Further, the information terminal 7 may include a rotary beacon light 17 as indicated by a broken line in FIG. 3. The rotary beacon light 17 is connected to the processor 21 via the system transmission path 30 and the interface circuit (not shown). The rotary beacon light 17 is a lamp that is controlled by the processor 21 and notifies a customer using the cart 10 and a store clerk of the location of the customer to be dealt with and a warning.

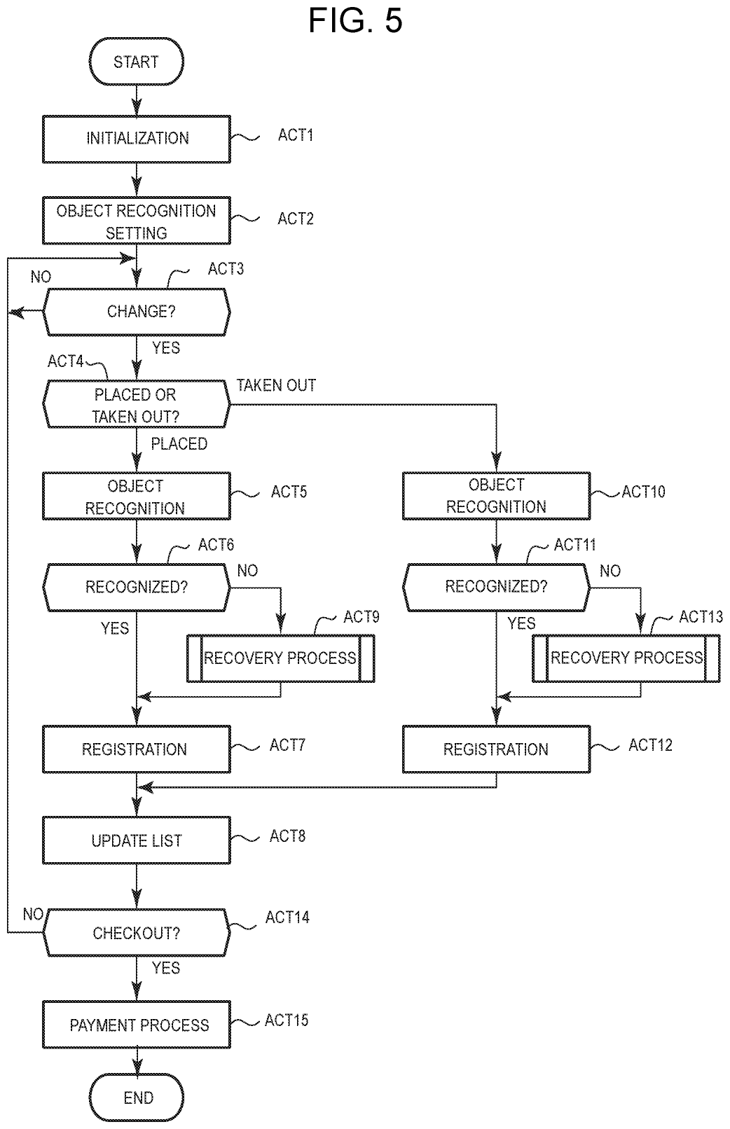

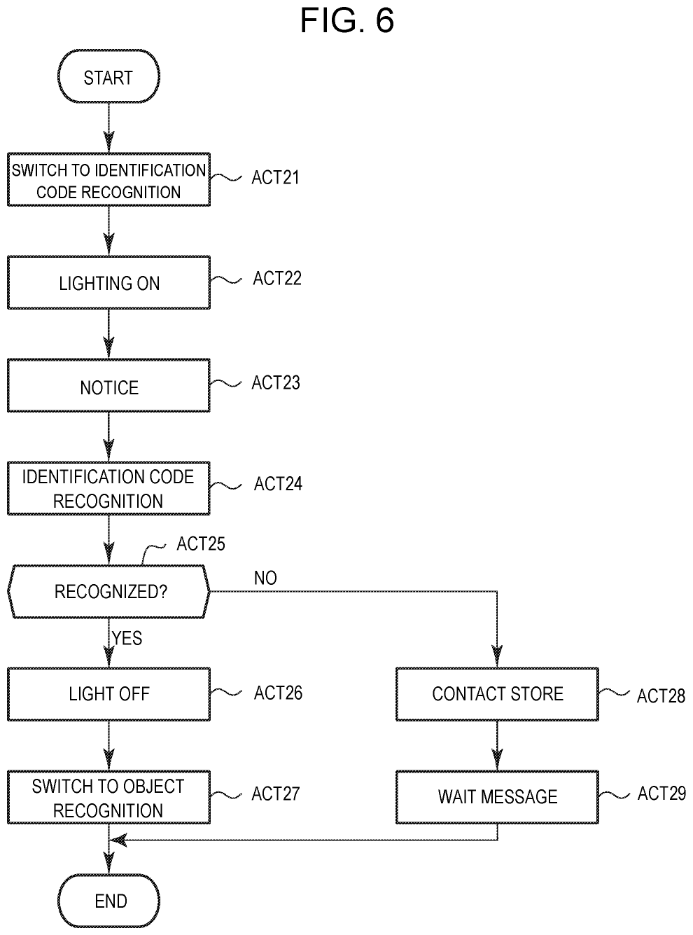

FIG. 5 is a flowchart showing a procedure of main information processing executed by the processor 21 of the information terminal 7 in accordance with the terminal program 24. FIG. 6 is a flowchart illustrating a procedure of a recovery process using identification code recognition in a case where object recognition cannot be performed.

In the following, the main operation of the cart POS device 1 will be described, referring to the flow chart shown in FIG. 5, when a customer performs a process for registering an item to be purchased using the information terminal 7 of the cart 10 and performing settlement himself/herself. The operation described below is an example. The procedure is not particularly limited as long as similar results are obtained.

First, a customer who enters a store takes a cart 10, operates the information terminal 7 to input data (ID) stored in his or her ID card or smart phone by the reader 16 to log in. When registering the member ID, the information terminal table 14 of the cart controller 3 associated with the cart 10 is initialized (ACT1). That is, the member ID of the new customer is registered in the member ID field 14b of the information terminal table 14 after the registered membership ID and the registered quantity of the item and the item are reset.

The processor 21 of the information terminal 7 starts the object recognition process by starting the application program for performing the object recognition and starting the shooting by the camera 8 (ACT2). At this time, the application program for recognizing the identification code may be similarly activated and placed in the standby status. The image data of the item captured by the camera 8 is stored in the main memory 22. In the main memory 22, an area for storing image data for a plurality of frames of an image of an item is secured. When the new image data is stored in the area, the processor 21 erases the oldest image data and stores the new image data in the reserved area.

Next, the customer determines whether the item has been put into or taken out of the basket 15. First, it is determined whether there is a change in the captured images (ACT3). The processor 21 compares the latest image data stored in the main memory 22 with the old image data stored immediately before to determine whether there is a change in the image. If there is no change in the captured images at this determination (ACT3: NO), the imaging is continued. On the other hand, in this determination, when there is a change in the captured images (ACT3: YES), it is determined whether the item is placed into or taken out from the basket 15 (ACT4). Whether the item is placed into the basket 15 of the cart 10 in this determination can be determined based on the direction in which the item moves in the shooting area. For example, if it is determined that the item crosses the shooting area in the vertical direction intersecting the bottom surface of the basket 15 in ACT3 in the downward direction approaching the bottom surface, ACT4 determines that the item is “placed into”, and the process proceeds to the following ACT5. On the other hand, in ACT4, if it is determined that the item crosses the shooting area in a direction away from the bottom surface upward, it is determined that the item has been “taken out”, and the process proceeds to a ACT10 described later. In ACT4, when it is determined that the item does not cross the shooting area in the vertical direction from the image and the item has moved in the obliquely downward direction or in the lateral direction at a short distance, the item in the basket 15 is only displaced, and it is considered that the detected image has not changed. Further, in addition to the determination based on the moving direction of the item, a weighing scale (not shown) may be disposed on the bottom surface of the basket 15, and the input/output of the item may be detected by a change in the increase or decrease in the weight.

In the determination of the above ACT4, when it is determined that the item has been put into the basket 15 (ACT4: placed), the processor 21 recognizes the item which has been put into the basket using the object recognition process using AI (ACT5). Specifically, the processor 21 recognizes the package (a shape, a color, a design, a symbol mark, or the like) of the moving item in the image. The processor 21 sets a rectangular area called a bounding box for the item in the latest image, performs image recognition of the item in the bounding box based on the trained data 26 stored in the auxiliary storage device 23, and recognizes the item.

Next, the processor 21 determines whether the item is recognized by the object recognition process (ACT6). If it is determined that the item is recognized in the package [first recognition result] (ACT6: YES), the item to be purchased is registered in the items to be purchased list in the information terminal table 14 as described above (ACT7), and the items to be purchased list is updated (ACT8). Specifically, the item registration notification is transmitted from the information terminal 7 to the cart controller 3. The cart controller 3 that has received the item registration notification updates the items to be purchased list by storing the item to be purchased data related to the item to be purchased in the items to be purchased list in the item to be purchased data field 14c of the information terminal table 14 associated with the member ID of the information terminal 7. The update of the items to be purchased list is performed every time a customer registers an item to be purchased at the information terminal 7.

On the other hand, in ACT6, if the processor 21 fails to recognize the item (ACT6: NO), the process is switched to an identification code recognition process in a subroutine shown in FIG. 6, which will be described later, to perform a recovery process of reading the identification code of the item to be purchased (ACT9) to recognize the item.

Next, when the item is recognized by the identification code recognizing process by the subroutine, the process proceeds to the above-described ACT7, where the item purchased by the customer at the information terminal 7 is registered in the items to be purchased list in the information terminal table 14, and the items to be purchased list is updated in ACT8. Further, in the above-described ACT4, when it is determined that the item registered in the processor 21 has been taken out from the basket 15 (ACT4: taking out), the processor 21 recognizes the item taken out using the object recognition process using the above-described AI (ACT10).

Next, the processor 21 determines whether the item is recognized by the object recognition process (ACT11). In this determination, if the item is recognized (ACT11: YES), the registration of the item registered in the items-to-be-purchased list in the information terminal table 14 is cancelled (ACT12), and the process proceeds to the above ACT8 to update the items-to-be-purchased list. Specifically, the information terminal 7 transmits an item cancellation notification to the cart controller 3. Upon receiving the item cancellation notification, the cart controller 3 deletes the data related to the item corresponding to the cancellation stored in the purchased item data field 14c of the information terminal table 14 associated with the member ID of the information terminal 7, thereby updating the items-to-be-purchased list. The update of the items-to-be-purchased list is performed every time the customer cancels the item already registered from the basket 15.

On the other hand, in ACT11, if the item is not recognized by the object recognition process (ACT11, NO), the process is switched to the identification code recognition process in the subroutine to be described later, and the recovery process for reading the identification code of the item to be canceled is performed (ACT13).

Next, if the item is recognized by the identification code recognizing process, the process proceeds to the above-described ACT12, where the item registered in the items-to-be-purchased list in the information terminal table 14 is canceled, and the items to be purchased list is updated in ACT8.

Next, it is determined whether to perform a checkout process (ACT14). When it is determined that the customer pays the price by touching the checkout button on the item registration screen of the information terminal 7 (ACT14, YES), the process proceeds to the following payment process step (ACT15), and when purchasing or returning the item (ACT14, NO), the process returns to ACT3, and the registration or retrieval of the item by the object recognition process is continued.

The payment process of ACT15 will be described. By touching the checkout button on the item registration screen, the processor 21 can shift to the checkout process. Although not specifically illustrated, in the checkout process, for example, the processor 21 generates a barcode based on the terminal ID allocated to the information terminal 7, and control the touch panel 28 to display the barcode. The checkout machine 5 reads the barcode and transmits a transaction query command including the terminal ID to the cart controller 3. The cart controller 3 generates payment data based on the items-to-be-purchased list registered in the purchased item data field 14c of the information terminal table 14 corresponding to the terminal ID included in the transaction query command, and returns the payment data to the checkout machine 5 that is the sender of the transaction query command. The checkout machine 5 prompts the customer to pay based on the received payment data, settles the item to be purchased, and ends the main routine related to the purchase.

Further, when the cart POS system 1 is configured as a system that can be settled by electronic money, the processor 21 controls the wireless unit 27 to transmit an electronic payment command including the terminal ID to the cart controller 3 through the access point 4. The cart controller 3 generates payment data based on the items-to-be-purchased list registered in the purchased item data field 14c of the information terminal table 14 corresponding to the terminal ID included in the electronic payment command, and transmits the payment data to the store server 2 together with the member ID stored in the member 14b of the information terminal table 14. The store server 2 acquires the electronic money user ID from the member payment record in the member payment database (not shown) by the member ID sent together with the payment data, and performs payment based on the payment data with the electronic money center EMC using the electronic money user ID.

Next, the subroutine of the recovery process using identification code recognition described above will be described with reference to the flowchart shown in FIG. 6.

First, the application program to be executed is switched from the object recognition process to the identification code recognition process (ACT21). When switching to the identification code recognition process, the camera 8 is switched from the continuous image mode in which object recognition is performed to the shooting mode in which proximity reading can be performed. This shooting mode is switched to the identification code close-up shooting mode in which continuous shooting is performed by, for example, shortening the exposure time as much as possible and shortening the focal length. In a configuration in which a plurality of cameras 8 are provided, one or more of the cameras 8 may be selected to switch to the identification code close-up mode. As described above, in the identification code recognition process, the blur of the captured screen greatly affects the identification code recognition as compared with the object recognition. Therefore, it is necessary to prevent blur from occurring in the captured bar, but illumination light for increasing the exposure amount of the subject is required by shortening the exposure time.

Next, the lighting unit 9 disposed adjacent to the camera 8 switched to the identification-code close-up mode is turned on, and the illumination light is emitted (ACT22). The illumination light not only increases the exposure amount of the object described above, but also functions as an indication of a reading position for the customer to read the identification code of the item. At this time, when the inside of the store is dark and the lighting unit 9 is already turned on as the auxiliary light during the object recognition, the lighting unit 9 on the side of the camera 8 that is switched to the identification code close-up mode continues to be turned on as it is, and the lighting unit 9 on the side of the camera 8 that is not switched to the identification code close-up mode is turned off. For example, in a case where only two cameras 8 disposed on both left and right sides of the basket 15 are switched to the identification code close-up mode, only the lighting unit 9 provided adjacent to the cameras 8 is turned on, and the lighting unit 9 disposed in front of and behind the basket 15 is turned off or not turned on. The reading of the identification code by the camera 8 may be not only a state in which the illumination light is turned on but also a state in which the identification code is blinking, as long as an exposure amount necessary for analyzing the identification code is obtained. When the identification code is read while the illumination light is blinking, it is necessary to synchronize the timing of the blinking with the timing of the shutter opening of the camera 8.

Next, the customer is notified by voice guide from the speaker 29 of the information terminal 7 that the object recognition of the item has failed and that the identification code of the item should be read in the identification code recognition process (ACT 23). Specifically, the voice guide instructs the identification code of the item to be placed over the illuminating light to be irradiated at the position in front of the camera 8 (i.e., the shooting area). In addition, in addition to the voice guide, a message may be displayed on the touch panel 28 of the information terminal 7 indicating that the object recognition of the item has failed and that the identification code is to be read.

In response to the voice guide, the customer takes the item that has failed in object recognition, and holds the identification code of the item in front of the camera 8 so as to be illuminated by the illumination light. At this time, if the identification code cannot be read at one time, the voice guide may be played back again so as to be read again. The processor 21 of the information terminal 7 recognizes the identification code captured by the camera 8 (ACT24). The processor 21 recognizes the identification code when the item code as the item information can be detected from the read identification code.

Next, the processor 21 of the information terminal 7 determines whether the identification code has been recognized (ACT25). In this determination, if the recognition result [second recognition result] indicates that the item is recognized by the identification code (ACT25: YES), the illumination light of the lighting unit 9 is turned off (ACT26). Thereafter, the application program to be executed is switched (ACT27) in order to change from the identification code recognition process to the object recognition process. In addition, with the switching to the object recognition process, the shooting mode of the camera 8 is adjusted so that the exposure time is extended so as to be suitable for the object recognition from the identification code close-up mode, and the mode is returned to the normal mode so that the read depth is also extended. After switching from the identification code recognition process to the object recognition process, the subroutine of the recovery process is ended, and the process proceeds to ACT7 or ACT12 of the main routine shown in FIG. 5.

Next, in the determination of ACT25 described above, when the information terminal 7 is unable to recognize the identification code (ACT25: NO), it is determined as an identification code recognition error, and a store terminal of the store server 2 (not shown) or an intercom carried by a store clerk is notified that an error call is being made by a customer. At this time, on the touch panel 28 of the information terminal 7, a message is displayed to tell the customer to wait there. (ACT26). This message indicates to stay at the current position and that a store clerk is called. In addition, the rotary beacon light 17 may be turned on in order to notify the store clerk of the position of the customer. Note that an error release button (not shown) is displayed on the touch panel 28 of the information terminal 7, and when the store clerk or the customer touches the error release button, the standby status by the error notification is released, and ACT7 or ACT12 of the main routine shown in FIG. 5 can be returned.

As described above, according to the cart POS system 1 including the item registration apparatus 100, when the camera 8 disposed around the basket 15 cannot recognize the item by the object recognition, the camera 8 is switched to the identification code close-up mode in which the exposure time is shorter and the reading depth is also shorter, and is used for reading the identification code. In other words, instead of using an identification code reading-only device that scans the light beam and reads the identification code, appropriate shooting of the identification code is performed by changing the shooting setting of the camera that performs object recognition. Further, by turning on the lighting unit 9, the reading position at which the identification code is held over the customer is made intuitively easy to understand while compensating for the amount of exposure light necessary for analyzing the identification code. This eliminates the need for a dedicated device (e.g., a barcode reader) to read the identification code. In addition, since the identification code can be read only by directing the surface on which the identification code of the item is affixed in the basket 15 to the camera 8 under the illumination light 9, it is possible to shorten the movement distance which is affected by the reading of the item. Further, when the package cannot be recognized, it is automatically switched to the identification code recognition, and the identification code of the item is read only by holding the identification code of the item over a portion illuminated by the illumination light 9 (i.e., shooting area), so that it is possible to reduce the time and effort of the shopping cart user.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An item registration apparatus for registering an item for purchase in a store, the item registration apparatus comprising:
a camera;
a lamp disposed adjacent to the camera; and
a processor configured to:
control the camera to capture a first image using first settings,
perform an object recognition process on the first image, and determine whether a package of an item is in the first image,
upon determining that a package of an item is in the first image, register the item for purchase,
upon determining that a package of an item is not in the first image, control the lamp to turn on and control the camera to capture a second image using second settings,
perform a code recognition process on the second image, and determine whether a code of an item is in the second image, and
upon determining that a code of an item is in the second image, register the item for purchase using the code.

2. The item registration apparatus according to claim 1, further comprising:
a touch panel, wherein
the processor is configured to, upon determining that a code of an item is not in the second image, control the touch panel to display an error message.

3. The item registration apparatus according to claim 2, further comprising:
a network interface connectable to a store clerk terminal, wherein
the processor is configured to, before the error message is displayed, control the network interface to transmit a notification to the store clerk terminal.

4. The item registration apparatus according to claim 1, wherein an exposure time of the camera in the second settings is shorter than an exposure time of the camera in the first settings.

5. The item registration apparatus according to claim 1, wherein a focal length of the camera in the second settings is shorter than a focal length of the camera in the first settings.

6. The item registration apparatus according to claim 1, wherein the camera and the lamp face a same direction such that an item to be imaged by the camera is irradiated by the lamp.

7. The item registration apparatus according to claim 1, further comprising:
a touch panel, wherein
the processor is configured to, after the lamp is turned on and before the second image is captured, control the touch panel to display a message indicating that the object recognition process failed, and the code recognition process is to be performed.

8. The item registration apparatus according to claim 1, wherein the processor is configured to, after the item is registered using the code:
control the lamp to turn off and control the camera to capture a third image using the first settings, and
perform the object recognition process on the third image.

9. The item registration apparatus according to claim 1, further comprising:
a network interface connectable to an external device that manages the item registered by the item registration apparatus, wherein
the processor is configured to control the network interface to transmit information about the registered item to the external device.

10. The item registration apparatus according to claim 9, wherein the processor is configured to generate a checkout code that is associated with the registered item and readable by a checkout machine for performing a payment process on the registered item.

11. A method for registering an item for purchase in a store, the method comprising:
controlling a camera to capture a first image using first settings;
performing an object recognition process on the first image, and determining whether a package of an item is in the first image;
upon determining that a package of an item is in the first image, registering the item for purchase;
upon determining that a package of an item is not in the first image, controlling a lamp disposed adjacent to the camera to turn on and controlling the camera to capture a second image using second settings;
performing a code recognition process on the second image, and determining whether a code of an item is in the second image; and
upon determining that a code of an item is in the second image, registering the item for purchase using the code.

12. The method according to claim 11, further comprising:
upon determining that a code of an item is not in the second image, displaying an error message.

13. The method according to claim 12, further comprising:
before the error message is displayed, transmitting a notification to a store clerk terminal.

14. The method according to claim 11, wherein an exposure time of the camera in the second settings is shorter than an exposure time of the camera in the first settings.

15. The method according to claim 11, wherein a focal length of the camera in the second settings is shorter than a focal length of the camera in the first settings.

16. The method according to claim 11, wherein the camera and the lamp face a same direction such that an item to be imaged by the camera is irradiated by the lamp.

17. The method according to claim 11, further comprising:
after the lamp is turned on and before the second image is captured, displaying a message indicating that the object recognition process failed, and the code recognition process is to be performed.

18. The method according to claim 11, further comprising, after the item is registered using the code:
controlling the lamp to turn off and controlling the camera to capture a third image using the first settings; and
performing the object recognition process on the third image.

19. The method according to claim 11, further comprising:
connecting to an external device that manages the item registered by the item registration apparatus; and
transmitting information about the registered item to the external device.

20. A cart point-of-sale (POS) system for registering an item for purchase in a store, the system comprising:
a cart;
a camera attached to the cart;
a lamp attached to the cart and disposed adjacent to the camera; and
a processor configured to:
control the camera to capture a first image using first settings,
perform an object recognition process on the first image, and determine whether a package of an item is in the first image,
upon determining that a package of an item is in the first image, register the item for purchase,
upon determining that a package of an item is not in the first image, control the lamp to turn on and control the camera to capture a second image using second settings,
perform a code recognition process on the second image, and determine whether a code of an item is in the second image, and
upon determining that a code of an item is in the second image, register the item for purchase using the code.
